(19) United States
(12) Patent Application Publication
(10) Pub. No.: US 2009/0271585 A1
(43) Pub. Date: Oct. 29, 2009

(54) DATA ACCESSING SYSTEM AND RELATED STORAGE DEVICE

(76) Inventors: Tung-Cheng Kuo, Hsin-Chu City (TW); Ching-Sung Yang, Hsinchu City (TW); Ruei-Ling Lin, Hsinchu County (TW); Cheng-Jye Liu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/342,083

(22) Filed: Dec. 23, 2008

Related U.S. Application Data
(60) Provisional application No. 61/047,431, filed on Apr. 24, 2008.

(51) Int. Cl. G06F 12/14; G06F 12/00

(52) U.S. Cl. 711/163; 711/E12.001; 711/E12.093

(57) ABSTRACT

A data accessing system includes a host computer and a storage device. The host computer has a first media access control (MAC) address, and the storage device includes a first storage region, a second storage region, and a controller. The first storage region is utilized for storing data. The second storage region stores a second media access control address. The controller couples to the first storage region and the second storage region for executing a security checking function to determine if the host computer is qualified to access the first storage region according to the first media access control address.

### CROSS REFERENCE TO RELATED APPLICATIONS

This application claims the benefit of U.S. provisional application No. 61/047,431, which was filed on Apr. 24, 2008 and is included herein by reference.

### BACKGROUND OF THE INVENTION

1. Field of the Invention

The present invention relates to a data accessing system and related storage device, and more particularly to a data accessing system and related storage device that perform security checking and setup functions through a hardware method.

2. Description of the Prior Art

In the field of data storage, a portable memory device, such as a multimedia card (MMC), compact flash (CF) card, or other type of memory card, is one of the most popular devices utilized to transfer data between different host computers. However, the data stored in the portable memory device could be easily accessed by an unauthorized person if the portable memory device is lost. Therefore, conventionally, a software security protection method is adopted to protect the data stored in the portable memory device from being stolen. The software security protection method sets a code to be stored in the portable memory device when the portable memory device is first used. Then, the code should be entered manually to the portable memory device and verified every time the portable memory device is accessed. This constant verification is inconvenient when the user needs to access the data stored in the potable memory device at a high frequency. Furthermore, the code may easily be decrypted by other persons when the software security protection method is utilized to protect the data stored in the portable memory device. Therefore, providing an efficient and convenient security checking method for a portable memory device is a significant concern in the data storage industry field.

### SUMMARY OF THE INVENTION

One of the objectives of the present invention is to provide a data accessing system and related storage device that performs security checking and setup functions through a hardware method.

According to an embodiment of the present invention, a data accessing system is disclosed. The data accessing system comprises a host computer and a storage device. The host computer has a first media access control (MAC) address, and the storage device comprises a first storage region, a second storage region, and a controller. The first storage region is utilized for storing data. The second storage region stores a second media access control address. The controller couples to the first storage region and the second storage region for executing a security checking function to determine if the host computer is qualified to access the first storage region according to the first media access control address.

According to another embodiment of the present invention, a storage device is disclosed. The storage device comprises a first storage region, a second storage region, and a controller. The first storage region is utilized for storing data. The second storage region stores a second media access control address. The controller couples to the first storage region and the second storage region for controlling data accessing operation of the first storage region according to a first media access control address.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data accessing system according to an embodiment of the present invention.

FIG. 2 is a flowchart illustrating a security accessing method performed upon a storage device by a host computer according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

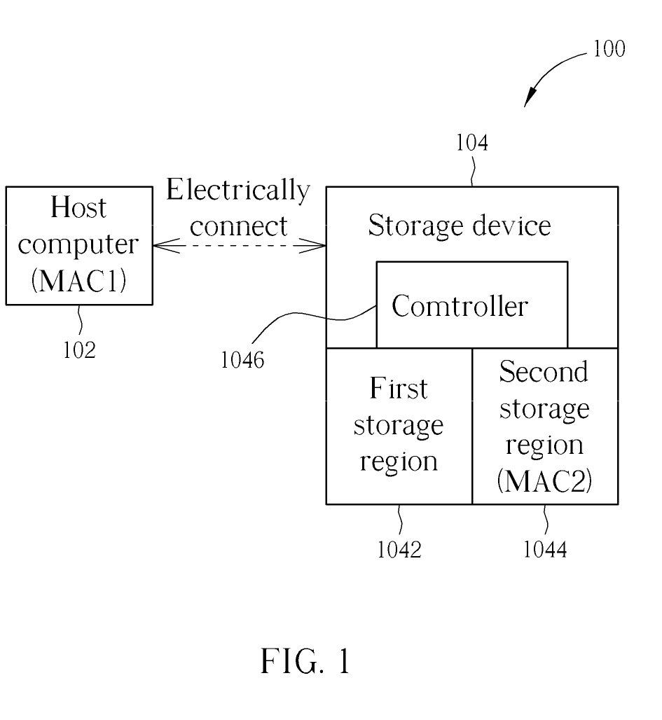

Please refer to FIG. 1. FIG. 1 is a diagram illustrating a data accessing system 100 according to an embodiment of the present invention. The data accessing system 100 comprises a host computer 102 and a storage device 104. The host computer 102 comprises a first media access control (MAC) address MAC1. The storage device 104 comprises a first storage region 1042, a second storage region 1044, and a controller 1046. The first storage region 1042 is utilized for storing data, the second storage region 1044 stores a second media access control address MAC2, and the controller 1046 couples to the first storage region 1042 and the second storage region 1044 for executing a security check function program according to the first media access control address MAC1 to determine if the host computer 102 is qualified to access the first storage region 1042. Please note that, according to the embodiment of the present invention, the storage device 104 can be implemented by a portable memory device, such as a NAND flash memory, but this is not meant to be a limitation of the present invention. In other words, any kinds of portable memory device belong to the scope of the present invention. Therefore, the present invention does not limit the format of data stored in the storage device 104.

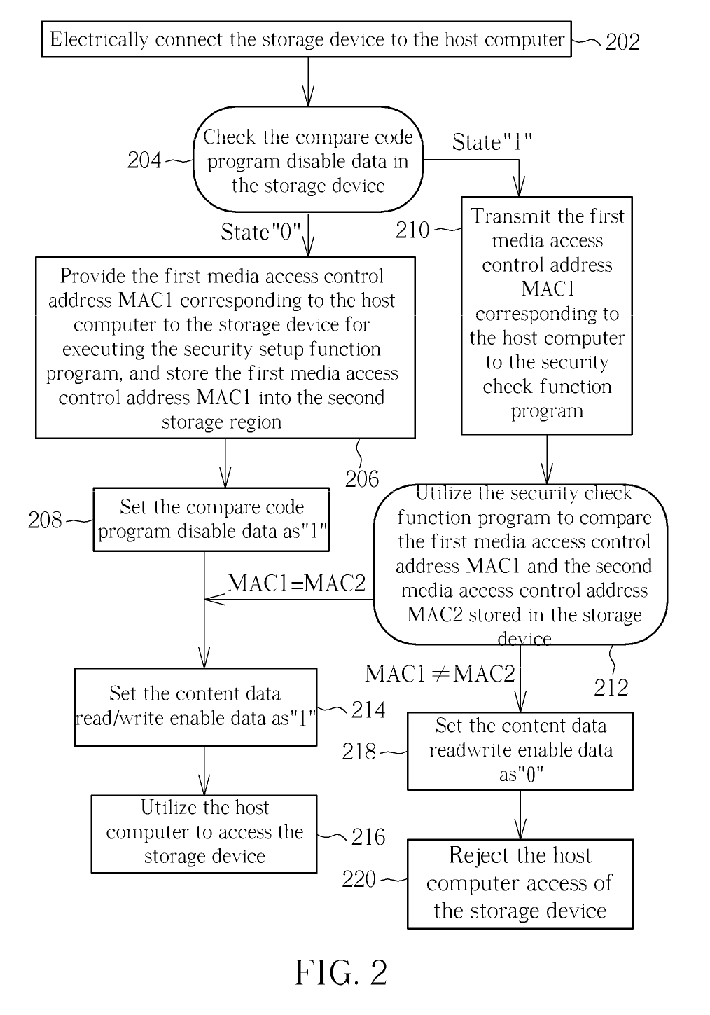

According to the embodiment of the present invention, in order to avoid the data stored in the storage device 102 being read by unauthorized persons when the storage device 102 is lost, the storage device 104 is assigned by a specific host computer 102 when the storage device 104 is first used by the specific host computer 102, which means that the storage device 104 is set to only allow access by the specific host computer 102. Please note that, although the embodiment of the present invention utilizes a host computer as an example, the storage device 104 is not limited to only being accessed by one host computer. In other words, those skilled in this art will readily understand that the storage device 104 can also be accessed by more than one specific host computer through some appropriate modifications of the data accessing system 100 after reading the disclosed embodiment of the present invention, and these modifications also belong to the scope of the present invention. As well as the security check function program, the storage device 104 of the embodiment of the present invention further stores a security setup function program, a content data read/write enable data, and a compare code program disable data. Please refer to FIG. 2. FIG. 2 is a flowchart illustrating a security accessing method performed upon the storage device 104 by the host computer 102 according to an embodiment of the present invention. Provided that substantially the same result is achieved, the steps of the flowchart shown in FIG. 2 need not be in the exact order shown and need not be contiguous, that is, other steps can be intermediate. The security accessing method comprises:

step 202: electrically connect the storage device 104 to the host computer 102;

step 204: check the compare code program disable data in the storage device 104; if the state of the compare code program disable data is “0”, go to step 206, if the state of the compare code program disable data is “1”, go to step 210;

step 206: provide the first media access control address MAC1 corresponding to the host computer 102 to the storage device 104 for executing the security setup function program, and store the first media access control address MAC1 into the second storage region 1044;

step 208: set the compare code program disable data as “1”, go to step 214;

step 210: transmit the first media access control address MAC1 corresponding to the host computer 102 to the security check function program;

step 212: utilize the security check function program to compare the first media access control address MAC1 and the second media access control address MAC2 stored in the storage device 104; if the first media access control address MAC1 is the same as the second media access control address MAC2, go to step 214, if the first media access control address MAC1 is different from the second media access control address MAC2, go to step 218;

step 214: set the content data read/write enable data as “1”;

step 216: utilize the host computer 102 to access the storage device 104;

step 218: set the content data read/write enable data as “0”;

step 216: reject the host computer 102 access of the storage device 104.

Therefore, when the storage device 104 is electrically connected to the host computer 102 (step 202), the host computer 102 first checks the state of the compare code program disable data in the storage device 104, in which the state of the compare code program disable data shows if the storage device 104 has already been used or has not been used yet. Therefore, when the state of the compare code program disable data is “0” (step 204), this indicates that the storage device 104 has not been used before, and thus the host computer 102 transmits the first media access control address MAC1 corresponding to the host computer 102 to the storage device 104, and stores the first media access control address MAC1 into the second storage region 1044 of the storage device 104. Then, the controller 1046 of the storage device 104 uses the first media access control address MAC1 to execute the security setup function program. In other words, the security setup function program is executed only when the storage device 104 is electrically connected to the host computer 102 for the first time.

Since there is only one specific media access control address that corresponds to a host computer, the storage device 104 only recognizes the host computer 102 after the first media access control address MAC1 is stored into the storage device 104. In other words, the storage device 104 can only be accessed by the host computer 102. Please note that the storage device 104 of the present invention does not limit recognition of the media access control address by the host computer 102. Any other specific identify unit that can uniquely represent the host computer 102 also belongs to the scope of the present invention. Then, the security setup function program sets the compare code program disable data of the storage device 104 to be “1”. According to the embodiment of the present invention, the first media access control address MAC1 stored in the second storage region 1044 of the storage device 104 can no longer be changed when the compare code program disable data of the storage device 104 is set to “1” (step 208). In other words, the second storage region 1044 of the storage device 104 can only be written to once. After that, only the host computer 102 corresponding to the first media access control address is allowed to access the storage device 104. On the other hand, in step 204, when the state of the compare code program disable data is “1”, this indicates that the storage device 104 has been used before. To determine if the storage device 104 can be accessed by the host computer 102, the host computer 102 transmits the first media access control address MAC1 corresponding to the host computer 102 to the storage device 104 (step 210) and stores it in the second storage region 1044. Then the controller 1046 of the storage device 104 reads the first media access control address MAC1 for executing the security check function program. The security check function program compares the first media access control address MAC1 and the second media access control address MAC2 to generate a comparison result.

Then, in accordance with the comparison result generated by the security check function program, when the first media access control address MAC1 is the same as the second media access control address MAC2, this means that the storage device 104 has been assigned for the host computer 102. Then, the controller 1046 of the storage device 104 sets the content data read/write enable data as “1” (step 214). Consequently, when the host computer 102 detects the content data read/write enable data is “1”, the host computer 102 determines that the storage device 104 can be accessed normally by the host computer 102 (step 216). On the other hand, when the first media access control address MAC1 is different from the second media access control address MAC2, this means that the storage device 104 is not assigned for the host computer 102. In this case, the controller 1046 of the storage device 104 sets the content data read/write enable data as “0” (step 218). Consequently, when the host computer 102 detects the content data read/write enable data is “0”, the host computer 102 determines that the storage device 104 cannot be accessed by the host computer 102 (step 220), and quits access of the storage device 104.

To sum up, the present invention utilizes a hardware method to implement a security check function upon the storage device 104, and the present invention not only provides a high speed security checking between the storage device 104 and the host computer 102, but further improves the data security of the data stored in the storage device 104. Furthermore, the cost of the storage device 104 can also be greatly reduced by utilizing the security checking method of the present invention.

Please note that those skilled in this art may be able to apply the present invention in similar fields after reading the disclosed operation and method of the present invention, and this also belongs to the scope of the present invention. In addition, those skilled in the field of electronic circuit design are also capable of implementing the security checking function and the security setup function of the present invention through the technique of electronic circuit design after reading the disclosed operation of the present invention, and this also belongs to the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data accessing system, comprising:
a host computer, having a first media access control (MAC) address; and
a storage device, comprising:
a first storage region, for storing data;
a second storage region, for storing a second media access control address; and
a controller, coupled to the first storage region and the second storage region, for executing a security checking function to determine if the host computer is qualified to access the first storage region according to the first media access control address.

2. The data accessing system of claim 1, wherein when the storage device is electrically connected to the host computer and when the second storage region of the storage device has not been written to, the controller further executes a security setup function to receive the first media access control address from the host computer, and writes the first media access control address into the second storage region to be the second media access control address.

3. The data accessing system of claim 2, wherein the storage device executes the security setup function when the storage device is electrically connected to the host computer for a first time.

4. The data accessing system of claim 1, wherein when the storage device is electrically connected to the host computer, the storage device executes the security checking function for comparing the first media access control address and the second media access control address to generate a comparison result, and determines if the second storage region can be accessed by the host computer according to the comparison result.

5. The data accessing system of claim 4, wherein when the comparison result indicates that the first media access control address is similar to the second media access control address, the storage device allows the host computer to access the second storage region.

6. The data accessing system of claim 2, wherein the second storage region of the storage device is only allowed to be written to once.

7. The data accessing system of claim 1, wherein the storage device is a portable storage device.

8. The data accessing system of claim 7, wherein the portable storage device is a portable memory device.

9. A storage device, comprising:
a first storage region, for storing data;
a second storage region, for storing a second media access control address; and
a controller, coupled to the first storage region and the second storage region, for controlling data accessing operations of the first storage region according to the first media access control address.

10. The storage device of claim 9, wherein the media access control address corresponds to a host computer.

11. The storage device of claim 9, where the storage device is a portable storage device.

12. The storage device of claim 9, wherein the portable storage device is a portable memory device.
